(19) United States
(12) Patent Application Publication
(10) Pub. No.: US 2013/0201215 A1
(43) Pub. Date: Aug. 8, 2013

(54) ACCESSING APPLICATIONS IN A MOBILE AUGMENTED REALITY ENVIRONMENT

(71) Applicants: John A. MARTELLARO, Arlington, VA (US); Jeffrey E. JENKINS, Clarksburg, MD (US); Brian A. BALLARD, Herndon, VA (US)

(72) Inventors: John A. MARTELLARO, Arlington, VA (US); Jeffrey E. JENKINS, Clarksburg, MD (US); Brian A. BALLARD, Herndon, VA (US)

(21) Appl. No.: 13/366,005

(22) Filed: Feb. 3, 2012

(51) Int. Cl. G09G 5/00

(52) U.S. Cl. 345/633

(57) ABSTRACT

An augmented reality system and method that allows a user to access, and more particularly, install and subsequently have access to an application on an augmented reality mobile device. The system and method enhances the augmented reality experience by minimizing or eliminating user interaction in the process of initiating the installation of the application. This is achieved, at least in part, through the use of a passively activated application program. It is passively activated in that it effects the application installation based on signals received and processed by the augmented reality mobile device, where the signals reflect the surrounding environment in which the augmented reality mobile device is operating. No direct interaction by the user of the augmented reality mobile device is required to initiate the installation of the application.

### FIELD OF THE INVENTION

The present invention relates to augmented reality methods and systems. More specifically, the present invention relates to methods and systems for accessing applications in a mobile, augmented reality environment. Even more specifically, the present invention relates to methods and systems for initiating the installation of applications and, thereafter, accessing the applications in an augmented reality mobile device.

### BACKGROUND OF THE INVENTION

Augmented reality is changing the way people view the world around them. Augmented reality, in general, involves augmenting one's view of and interaction with the physical, real world environment with graphics, video, sound or other forms of computer-generated information. Augmented reality introduces the computer-generated information so that one's augmented reality experience is an integration of the physical, real world and the computer-generated information.

Augmented reality methods and systems are often implemented in mobile devices, such as smart phones, tablets and, as is well known in the art, augmented reality glasses having wireless communication capabilities. In fact, mobile device technology is, in part, driving the development of augmented reality technology. As such, almost any mobile device user could benefit from augmented reality technology. For example, a tourist wearing a pair of augmented reality glasses wishing to find a suitable restaurant may select an option that requests a listing of local restaurants. In response, a computer-generated list of local restaurants may appear in the user's field of view on the augmented reality glasses.

In general, software running on mobile devices can be categorized as active software or passive software. Active software requires that the user perform some affirmative action to initiate the software's functionality. Passive software does not require the user to perform any affirmative action to initiate the software's functionality. In the above example, the tourist wishing to find a suitable restaurant must perform one or more affirmative actions in order to obtain the local restaurant listing. For example, the tourist must select the appropriate application so that the operating system will execute the application. The tourist then may have to select an option requesting the specific restaurant listing. It will be understood that the software application providing the restaurant listing is active software.

To some extent, the use of active software applications defeats the purpose of and diminishes the experience that one expects when using augmented reality technology. For instance, in a virtual reality environment, a user must interact with the technology—select a program, enter data, make a selection from a menu. In the real world, one isn't interacting with the virtual world at all. In the augmented reality world, one wants the experience to be as near a real experience as possible, not a virtual experience. It is, therefore, desirable that augmented reality software applications make the user's experience as much like the real world as possible and less like the virtual world.

### SUMMARY OF THE INVENTION

The present invention obviates the aforementioned deficiencies associated with conventional augmented reality systems and methods. In general, the present invention involves an augmented reality system and method that allows a user to initiate the installation of an application on an augmented reality mobile device (e.g., by downloading into the device over a wireless network connection), with reduced or no direct user interaction. This, in turn, substantially enhances the user's augmented reality experience.

Thus, in accordance with one aspect of the present invention, the above-identified and other objects are achieved by an augmented reality mobile device. The device comprises a processor that includes a module configured to receive and process a first signal, where the first signal reflects the environment in which the augmented reality mobile device is operating. The module is also configured to generate a second signal based on the processed first signal. The mobile device also comprises a passively activated application program. The functionality of the passively activated application program is activated without direct user interaction. The passively activated application program is configured to receive the second signal from the processor, recognize an environmental trigger encoded in the second signal, and effect the installation of an application in the augmented reality mobile device, where the application corresponds with the environmental trigger.

In accordance with another aspect of the present invention, the above-identified and other objects are achieved by a method of installing an application in an augmented reality mobile device. The method comprises receiving and processing a first signal that reflects the environment in which the augmented reality mobile device is operating. The method also comprises generating a second signal that is based on the processed first signal. Then, without any direct, prior user interaction, the method comprises decoding and analyzing the second signal for the presence of an environmental trigger. If it is determined that an environmental trigger is encoded in the second signal, an application is installed on the augmented reality mobile device, where the installed application corresponds with the environmental trigger.

### BRIEF DESCRIPTION OF THE DRAWINGS

Several figures are provided herein to further the explanation of the present invention. More specifically:

FIG. 1 illustrates and exemplary pair of augmented reality glasses;

FIG. 2 is a diagram that illustrates the general concept of the present invention;

FIG. 3 is a system block diagram illustrating the configuration of the software, in accordance with exemplary embodiments of the present invention;

FIG. 4 is a signaling diagram that exemplifies how the passive app store program works in conjunction with the environmental processor, in accordance with exemplary embodiments of the present invention; and

FIG. 5 is a sequence of story boards that coincide with the signaling diagram of FIG. 4.

### DETAILED DESCRIPTION

It is to be understood that both the foregoing general description and the following detailed description are exemplary. As such, the descriptions herein are not intended to limit the scope of the present invention. Instead, the scope of the present invention is governed by the scope of the appended claims.

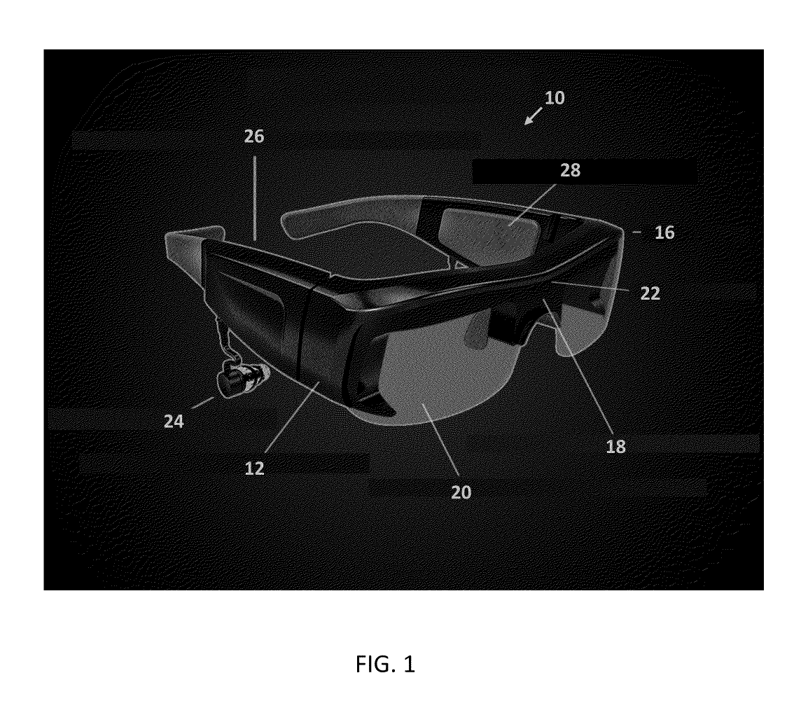

FIG. 1 illustrates an exemplary pair of augmented reality glasses. Although the present invention may be implemented in mobile devices other than glasses, the preferred mobile device is presently a pair of augmented reality glasses such as the exemplary glasses of FIG. 1. It is, therefore, worth describing the general features and capabilities associated with augmented reality glasses, as well as the features and capabilities that are expected to be found in future generation augmented reality glasses. Again, one skilled in the art will, given the detailed description below, appreciate that the present invention is not limited to augmented reality glasses or any one type of augmented reality mobile device.

As shown in FIG. 1, augmented reality glasses 10 include features relating to navigation, orientation, location, sensory input, sensory output, communication and computing. For example, augmented reality glasses 10 include an inertial measurement unit (IMU) 12. Typically, IMUs comprise axial accelerometers and gyroscopes for measuring position, velocity and orientation. In order for a mobile device to provide augmented reality capabilities, it is often necessary for the mobile device to know its position, velocity and orientation within the surrounding real world environment and/or its position, velocity and orientation relative to real world objects within that environment. IMUs are well known and commonly used in air and water craft.

The augmented reality glasses 10 also include a Global Positioning System (GPS) unit 16. GPS units receive signals transmitted by a plurality of geosynchronous earth orbiting satellites in order to triangulate the location of the GPS unit. In more sophisticated systems, the GPS unit may repeatedly forward a location signal to an IMU to supplement the IMUs ability to compute position and velocity, thereby improving the accuracy of the IMU. GPS units are also well known.

As mentioned above, the augmented reality glasses 10 include a number of features relating to sensory input and sensory output. Here, augmented reality glasses 10 include at least a front facing camera 18 to provide visual (e.g., video) input, a display (e.g., a translucent or a stereoscopic translucent display) 20 to provide a medium for displaying computer-generated information to the user, a microphone 22 to provide sound input and audio buds/speakers 24 to provide sound output.

The augmented reality glasses 10 must have network communication capabilities, similar to conventional mobile devices. As such, the augmented reality glasses 10 will be able to communicate with other devices over network connections, including intranet and internet connections through a cellular, WIFI and/or Bluetooth transceiver 26.

Of course, the augmented reality glasses 10 will also comprise an on-board microprocessor 28. The on-board microprocessor 28, in general, will control the aforementioned and other features associated with the augmented reality glasses 10. The on-board microprocessor 28 will, in turn, include certain hardware and software modules and components described in greater detail below.

In the future, augmented reality glasses may include many other features to further enhance the user's augmented reality experience. Such features may include an IMU with barometric sensor capability for detecting accurate elevation changes; multiple cameras; 3D audio; range finders; proximity sensors; an ambient environment thermometer; physiological monitoring sensors (e.g., heartbeat sensors, blood pressure sensors, body temperature sensors, brain wave sensors); and chemical sensors. One of ordinary skill will understand that these additional features are exemplary, and still other features may be employed in the future.

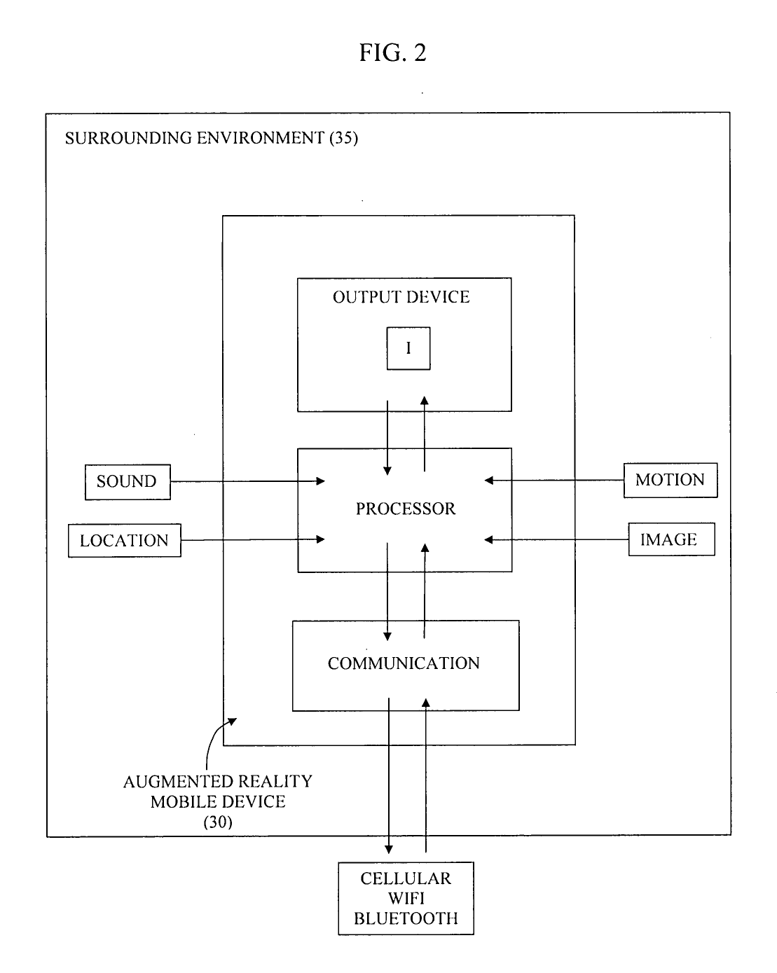

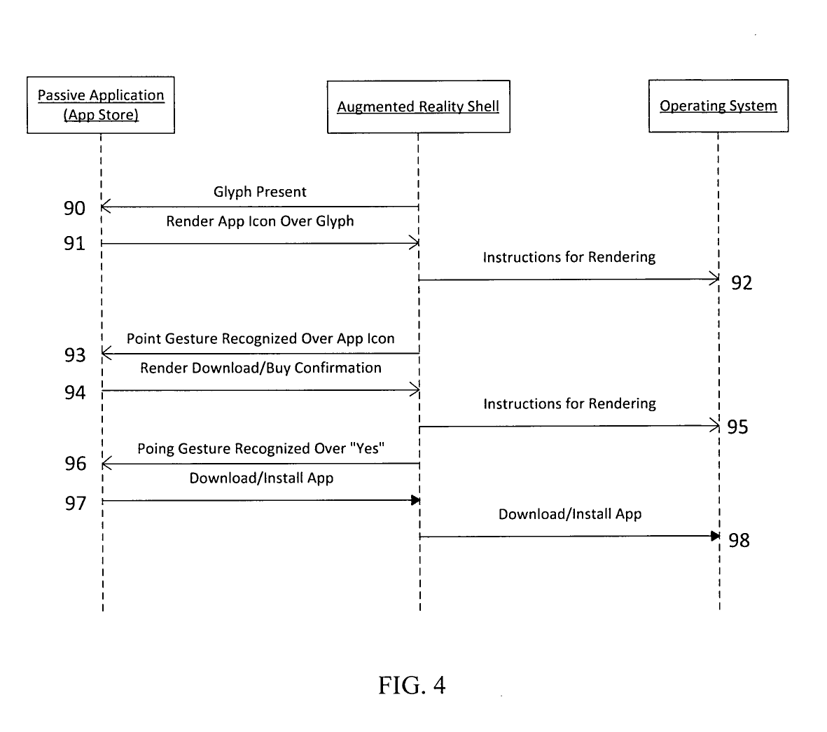

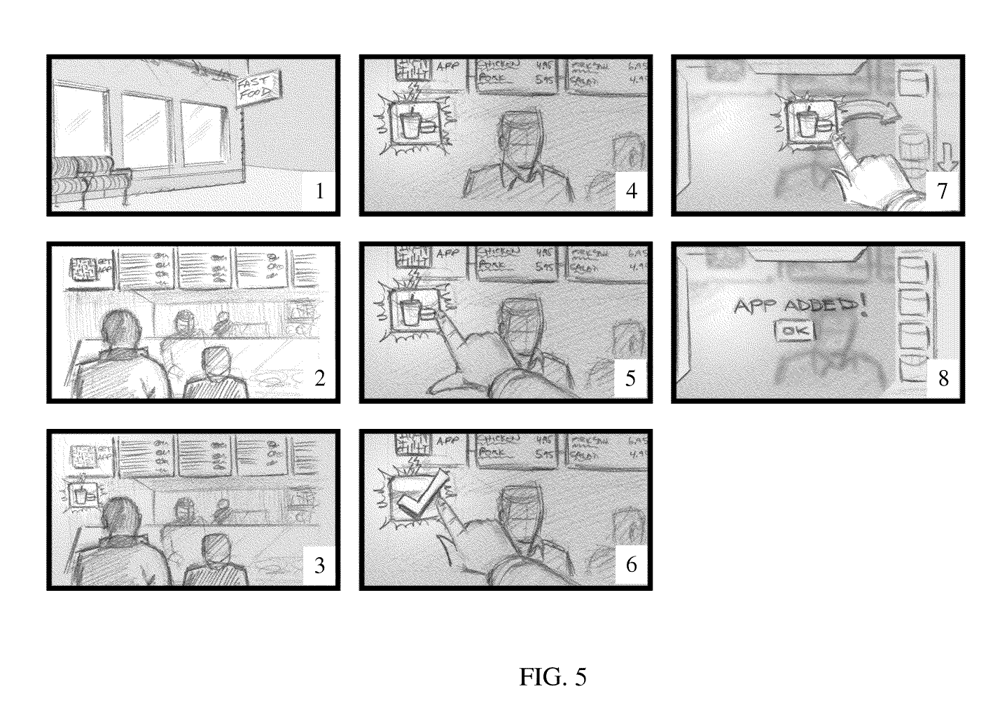

FIG. 2 is a diagram that illustrates the general concept of the present invention. As shown, the augmented reality mobile device, e.g., the augmented reality glasses 10 illustrated in FIG. 1, is operating in a surrounding, real world environment 35. In the example described below, with respect to FIGS. 4 and 5, the surrounding, real world environment is a fast food restaurant. However, it will be understood that the surrounding, real world environment could be anywhere in the world, inside or outside.

As explained above with respect to FIG. 1, the augmented reality mobile device, e.g., the augmented reality glasses 10, may include a number of features relating to navigation, orientation, location, sensory input, sensory output, communication and computing. In FIG. 2, only a few of these features are shown in order to simplify the general concept of the present invention. These include an output device (e.g., the stereoscopic translucent display 20), a processor (e.g., on-board microprocessor 28), and communication components (e.g., the cellular, WIFI, Bluetooth transceivers 26).

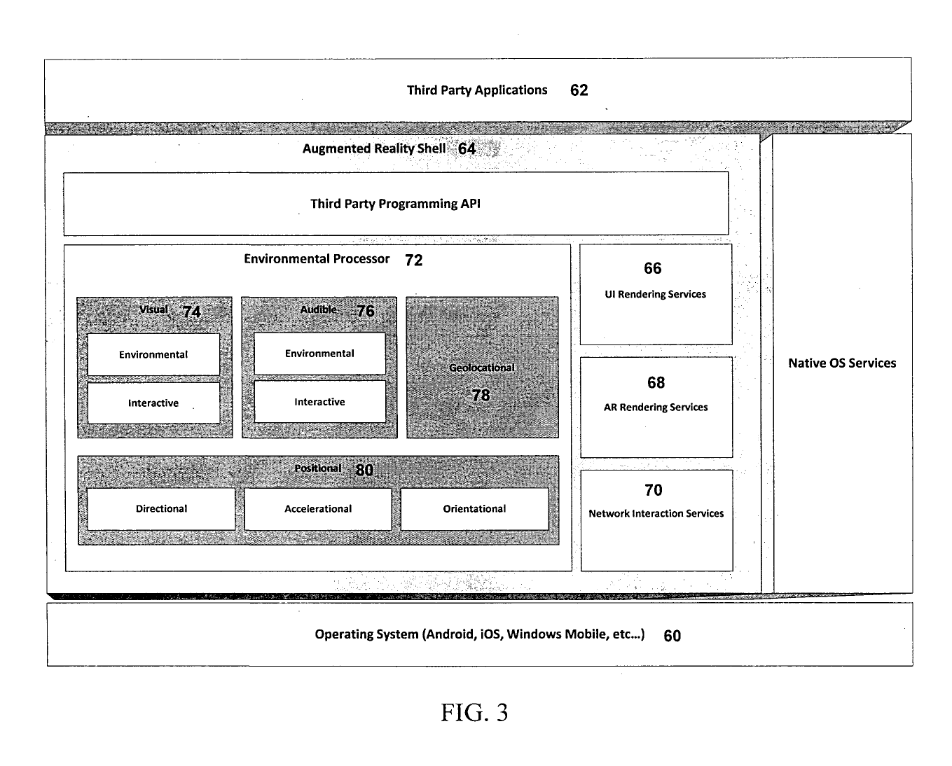

It will be understood that the term “processor,” in the context of FIG. 2, is intended to broadly cover software, hardware and/or a combination thereof. Later, with regard to FIG. 3, a number of specific features will be described. It will be further understood that some of these specific features (e.g., the features associated with the environmental processor) may be covered by the “processor” shown in FIG. 2.

The processor will, of course, execute various routines in order to operate and control the augmented reality mobile device 30. Among these is a software program, referred to herein and throughout this description as the “app store.” In accordance with exemplary embodiments of the present invention, the processor executes the app store program in the background. In accordance with one exemplary embodiment, the processor executes the app store program in the background whenever the augmented reality mobile device is turned on and operating. In another exemplary embodiment, the user may have to initiate the app store program, after which time, the processor will continue to execute the program in the background.

As stated above, the output device may be a translucent display (e.g., translucent display 20). However, other device and display types are possible. For example, if the output device is a display device, the display device may comprise transparent lenses rather than translucent lenses. The display device may even involve opaque lenses, where the images seen by the user are projected onto opaque lenses based on input signals from a forward looking camera as well as other computer-generated information. Furthermore, the display may employ a waveguide, or it may project information using holographic images. In fact, the output device may involve something other than a display. As mentioned below, the output device may involve audio, in lieu or, most likely, in addition to video. The key here is that the present invention is not limited by the type and/or nature of the output device.

In FIG. 2, the augmented reality mobile device, e.g., the augmented reality glasses 10, is shown as a single device, where the output device, processor and communication module are all shown as being integrated in one unit. However, it will be understood that the configuration of the augmented reality mobile device may not be integrated as shown. For example, the processor and communication module may be housed together and integrated in a single device, such as a smart phone with augmented reality capabilities, while the output device may be a removable translucent display that plugs into the smart phone. Thus, configurations other than the integrated configuration shown in FIG. 2 are within the scope and spirit of the present invention.

The app store program is passive. As explained above, this means, the functionality associated with the app store program is capable of being initiated by any one of a number of triggers that are present or occur in the surrounding, real world environment. Direct user action, on the other hand, is not required to initiate the app store functionality as is the case with software providing similar or like functionality in conventional augmented reality methods and systems. As illustrated in FIG. 2, the passive triggers may come in any one of a number of forms: a sound (e.g., a particular tone or musical sequence) as picked up by the built in microphone 22, an image such as a recognizable glyph (e.g., a QR code or a logo of a known fast food restaurant chain) as captured by the camera, a location (e.g., a particular GPS coordinate) as determined by the GPS unit 16, a motion (e.g., the movement of the user's head or body) as determined by the IMU 12, or a recognizable WIFI hotspot. It will be appreciated by those skilled in the art that an app store program, as described herein above, where the functionality may be initiated both actively and passively is within the scope and spirit of the invention.

At the present time, the most common triggers are likely to be computer vision based, where the camera (e.g., camera 18) captures an image. Within that image there may be an object or glyph that the app store program recognizes. The recognition of the object or glyph then causes an event, for example, the display of computer-generated information specifically corresponding to that object or glyph. The computer-generated information may be an icon representing an application that the user may wish to install (e.g., download). In the fast food restaurant example described in detail below, the application, if the user chooses to install it, might provide the user with a coupon or other special offers available at the restaurant. The application may allow the user to view a food and beverage menu through the augmented reality mobile device so the user can order food without standing in line—a benefit if the restaurant happens to be crowded. The application may provide nutritional information about the various food and beverage items offered at the restaurant. As technology advances and marketing becomes more creative, other types of triggers are likely to become more prevalent.

In another example, the trigger passively initiating the app store program may be a tone played over a sound system in the surrounding environment. The tone would be picked up by the microphone (e.g., microphone 22). If the app store program recognizes the tone, the app store program then causes an event, such as the display of computer-generated information specifically corresponding to that tone.

In yet another example of a trigger passively initiating the app store program, the user may be attending a sporting event, such as a baseball game. If the augmented reality mobile device has a temperature sensor, and the actual temperature at the game exceeds a predefined temperature, that combined with the GPS coordinates of the stadium or a particular concession stand at the stadium may trigger the app store program to display computer-generated information, such as an icon that, if selected by the user, initiates the installation of an application that offers a discount on a cold beverage. On a cool day, the application may, alternatively, offer the user a discount on a hot beverage or a warm meal.

Social triggers are also possible. In this example, a group of like users who are present in a common place, based on the GPS coordinates of that place, may receive a special, limited offer. For example, if the like users are attending a concert at a venue with GPS coordinates that are recognized by the app store program, the computer-generated information may be an icon that, if selected by the user would make the user eligible to receive a limited edition t-shirt. The offer may be made available only to the first 100 users that select the icon and install (e.g., download) the corresponding application. In another example of a social trigger, a user may subscribe to a particular social networking group. Then, if one or more subscribers in that group, in proximity to the user, just downloaded a particular application, the user's mobile device may receive a signal over a network connection, where that signal serves as an environmental trigger initiating the functionality of the app store program to, thereafter, offer the user the same application. One might imagine that this social feature will become quite popular and may be a major driving force in promoting products and motivating users to perform some activity.

Table I below is intended to provide a list of exemplary triggers. These triggers may be supported by conventional augmented reality technology, and some may be more likely in the near future as the technology advances. In no way is the list in Table I intended to be limiting in any way.

TABLE I

| Trigger | Example |
|---|---|
| Visual | Image Recognition |
| | Face Recognition |
| | Text |
| | Logo |
| | Building |
| | Glyphs |
| | Other Objects |
| | Light Detection |
| | Brightness of Light |
| | Color Patterns (e.g. red, white, and blue) |
| Sound | Music Detection |
| | Beat Pattern Detection |
| | Tone Detection |
| | Speech Detection |
| | Language Detection |
| Proximity | RF |
| | Electromagnetic |
| | Range Finder |
| Temperature | Changes in Temperature (Drop from inside to outside) |
| | Thresholds |
| IMU Based | Gyroscopic |
| | Navigational (Magnetometer) |
| | Inertial |
| Geo-location | Elevation |
| | Latitude/Longitude |
| Temporal | Particular Date/Time |
| Social | Group of other participants present |
| Haptic | User triggers by pressing button, or selecting something |
| Network Signal | Group subscription |
| Combinations | Any combination of the above |

After the app store program is passively triggered to present computer-generated information to the user through the augmented reality mobile device (e.g., by displaying a corresponding icon on the display or by playing a corresponding audio sequence through the ear buds/speakers), the user now may be required to take some affirmative action (referred to herein as a “processing action”) in order to utilize or otherwise take advantage of the computer-generated information provided by the app store program.

It will be understood that a processing action may take on any number of different forms. Computer Vision, for example, offers one convenient way to effect a processing action. In the world of augmented reality, computer vision may allow the user to reach out and “touch” the virtual object (e.g., the icon presented on the display). It will be understood, however, that simply placing a hand over the virtual object may result in false acceptances or accidental selection as moving one's hand in front of or over the augmented reality mobile device may be a common thing to do even when the user is not trying to initiate a process action. Accordingly, the processing action should be somewhat unique to advert false acceptances or accidental selections. Thus, the processing action may come in the form of fingers bending in a unique pattern, or moving one's hand in along a predefined path that would be hard to accidentally mimic without prior knowledge. Another example might be the use of the thumb extending outward, and then moving one's hand inward to symbolize a click. The camera would of course capture these user movements and the app store program would be programmed to recognize them as a processing action.

Computer vision is, of course, only one way to implement a processing action. Sound is another way to implement a processing action. With advancements in speech detection, the app store program will be able to decipher specific words, for example, “select icon,” “purchase item,” “order product” or “cancel order,” just to name a few. In addition, specific sounds, tones, changes in pitch and amplitude all could be used to implement a user processing action.

Table II below is intended to summarize some of the ways in which a user may initiate a processing action. Again, the list presented in Table II is exemplary, and it is not intended to be limiting in any way.

TABLE II

| User Action Type | Example |
|---|---|
| Computer Vision | Hand Recognition with Gestures |
| | Motion Detection |
| Sound | Keyword (such as “purchase”) |
| | Tone (beep, bop, and boops, whistles) |
| Haptic | Buttons on the augmented reality mobile |
| | device for selection |
| | Touch screen input on mobile device |
| Proximity/RF | User walks to the vicinity of the object |
| Combinations | Any combination of the above |

FIG. 3 is a system block diagram illustrating the configuration of the software residing in the processor, in accordance with exemplary embodiments of the present invention. As illustrated, the software is configured into three layers. At the lowest layer is the mobile device operating system 60. The operating system 60 may, for example, be an Android based operating system, an IPhone based operating system, a Windows Mobile operating system or the like. At the highest layer is the third party application layer 62. Thus, applications that are designed to work with the operating system 60 that either came with the mobile device or were downloaded by the user reside in this third layer. The middle layer is referred to as the augmented reality shell 64. In general, the augmented reality shell 64 is a platform that provides application developers with various services, such as user interface (UI) rendering services 66, augmented reality (AR) rendering services 68, network interaction services 70 and environmental services which are, in turn, provided by the environmental processor 72.

The environmental processor 72 plays a very important role in the present invention. The environmental processor 72 may be implemented in software, hardware or a combination thereof. The environmental processor 72 may be integrated with other processing software and/or hardware, as shown in FIG. 3, or it may be implemented separately, for example, in the form of an application specific integrated chip (ASIC). In accordance with a preferred embodiment, the environmental processor 72 is running as long as the augmented reality mobile device is turned on. In general, the environmental processor 72 is monitoring the surrounding, real world environment of the augmented reality mobile device based on input signals received and processed by the various software modules. These input signals carry information about the surrounding, real world environment and it is this information that allows the app store program to operate passively in the background, i.e., without direct user interaction as explained above. Each of the exemplary environmental processor modules will now be identified and described in greater detail. The modules, as suggested above, may be implemented in software, hardware or a combination thereof.

The visual module 74 receives and processes information in video frames captured by the augmented reality mobile device camera (e.g., camera 18). In processing each of these video frames, the visual module 74 is looking for the occurrence of certain things in the surrounding, real world environment, such as, objects, glyphs, gestural inputs and the like. The visual module 74 includes two components, and environmental component and an interactive component. The environmental component is looking for objects, glyphs and other passive occurrences in the surrounding environment. In contrast, the interactive component is looking for gestural inputs and the like.

The visual module 74 is but one of several modules that make up the environmental processor 72. However, it will be understood that if the functionality associated with the visual module 74 is particularly complex, the visual module 74 may be implemented separate from the environmental processor 72 in the form of it own ASIC.

The audible module 76 receives and processes signals carrying sounds from the surrounding, real world environment. As shown, the audible module 76 includes two components, a speech module for detecting and recognizing words, phrases and speech patterns, and a tonal module for detecting certain tonal sequences, such as musical sequences.

The geolocational module 78 receives and processes signals relating to the location of the augmented reality mobile device. The signals may, for example, reflect GPS coordinates, the location of a WIFI hotspot, or the proximity to one or more local cell towers.

The positional module 80 receives and processes signals relating to the position, velocity, acceleration, direction and orientation of the augmented reality mobile device. The positional module 80 may receive these signals from an IMU (e.g., IMU 12).

The app store program is a separate software element. In accordance with exemplary embodiments of the present invention, it resides in the third party application layer 62, along with any other applications that either came with the mobile device or were later downloaded by the user. Alternatively, the app store program may reside in the augmented reality shell 64. The app store program communicates with the various environmental processor software modules in order to recognize triggers embedded in the information received and processed by the environmental processor software modules. In addition, the app store program communicates with the other software elements in the shell to, for example, display virtual objects and other information to the user or reproduce audible sequences for the user. The app store program communicates with yet other software elements in the shell to upload or download information over a network connection.

FIG. 4 is a signaling diagram that illustrates, by way of an example, how the passive app store program works in conjunction with the environmental processor 72 in the augmented reality shell 64, and how the augmented reality shell 64 works in conjunction with the operating system 60, in order to provide the user with the features and capabilities associated with the app store program. FIG. 5 is a story board that coincides with the signaling diagram of FIG. 4. The story board pictorially shows the user's view through a pair of augmented reality glasses (e.g., augmented reality glasses 10), and the sequence of user actions coinciding with the signals illustrated in the signaling diagram of FIG. 4.

The example illustrated in FIGS. 4 and 5 begins with the user walking into a fast food restaurant (see story board frames 1 and 2). There are two other customers ahead of the user in line at the restaurant. As the user approaches the counter, an icon is rendered on the translucent display of the user's augmented reality glasses in the user's field of view. In the present example, the environmental processor 72, and more specifically, the environmental component of the visual module 74 in the environmental processor 72, detected a glyph (or object) 73 in one or more video frames provided by camera 18. The glyph 73 may be a coded image associated with that particular fast food establishment, such as a bar code or a Quick Response (QR) code. Alternatively, the glyph 73 may be a recognizable company logo. In any event, the detection of the glyph 73 by the environmental component of the visual module 74 results in the visual module 74 sending a signal 90 (FIG. 4) that is received by the app store program which is, as explained above, passively running in the background. It will be understood that signal 90 maybe broadcast by the visual module 74 to all applications running and communicating, at that time, with the augmented reality shell 64. However, only those applications designed to properly decode or recognize signal 90 will be able to utilize the information associated with signal 90. In the present example, at least the app store program is designed to properly decode (e.g., the QR code) and utilize the information embedded therein.

In response to decoding signal 90, the app store program then generates a signal 91 and sends it back to the augmented reality shell 64 (FIG. 4). In the present example, signal 91 contains an instruction for the augmented reality shell 64, and more specifically, the AR rendering service module 68 in the augmented reality shell 64, to present a particular icon 71 on the translucent display 20 of the user's augmented reality glasses 10, within the user's field of view. In order to display the icon 71 on the translucent display 20, it may be necessary for the AR rendering service module 68 to forward the instructions of signal 92 to a rendering engine (not shown) associated with operating system 60.

The icon 71 would then appear on the translucent display 20 as illustrated in story board frame 3 (FIG. 5). It is important to note that, in accordance with exemplary embodiments of the present invention, the rendering engine in the operating system 60 working together with the environmental processor 72, displays icon 71 in such a way that there is clear, natural association between the icon 71 and glyph 73. Thus, as illustrated in story board 4 (FIG. 5), the icon 71 continues to be rendered on translucent display 20 such that it always appears to the user to overlay or be in proximity of glyph 73 even as the user moves about within the restaurant. This natural association between the icon 71 and glyph 73 allows the user to better understand and/or interpret the nature and purpose of icon 71.

It is important to reiterate that, in accordance with a preferred embodiment, the app store program is passively running in the background. Thus, the process of recognizing the object or glyph in the fast food restaurant, the generation and processing of signals 90, 91 and 92, and the rendering of the icon 71 on the translucent display 20, occurred without any direct action or involvement by the user. It is also important to reiterate that while the passive triggering of the app store program was, in the present example, caused by the presence of and recognition of a real world glyph in the fast food restaurant, alternatively, it could have been caused by a sound or tonal sequence picked up by microphone 22, and detected and processed by the tonal component of the audible module 76 in environmental processor 72. Still further, it could have been caused by the augmented reality mobile device 10 coming within a certain range of the GPS coordinates associated with the fast food restaurant, as detected by the geolocational module 78. Even further, it could have been caused by the augmented reality mobile device, or more specifically, the network interaction service module 70, detecting the WIFI hotspot associated with the fast food establishment. One skilled in the art will readily appreciate that these passive triggers are all exemplary, and other triggers are possible, as illustrated in Table I above.

Returning to the exemplary method illustrated in FIGS. 4 and 5, the user, seeing the icon 71 on the translucent display 20, may decide to accept the application associated with icon 71. Because the icon 71 is visible on the translucent display 20, the user, in this example, accepts the application by pointing to icon 71, as illustrated in story board 5 (FIG. 5). The user action of pointing to icon 71 is captured by camera 18 and extracted from the corresponding video frame(s) by the interactive component of visual module 74. In response, visual module 74 generates signal 93 which is received and decoded by the app store program (FIG. 4). The app store program then effects the user's acceptance of the application corresponding to icon 71 by sending a confirmation signal 94 back to the augmented reality shell 64 (FIG. 4). The augmented reality shell 64 may send an instruction signal 95 to the rendering engine in the operating system 60 to modify the display of icon 71 so as to reflect the user's acceptance of the corresponding application. This is illustrated in story board 6 (FIG. 5) with the rendering of a “V” over icon 71.

Although, in the present example, the application is accepted by selecting icon 71, presented on translucent display 20, through the use of a hand gesture, it will be understood from Table II above that the way in which the user accepts the application may differ based on the manner in which the app store program presents the computer-generated information to the user. If, alternatively, the app store program presents the user with an audible option (in contrast to a visual option like icon 71) in response to its recognition of glyph 73, for example, the audible sequence, “ARE YOU INTERESTED IN DOWNLOADING A DISCOUNT FOOD COUPON,” user acceptance may take the form of speaking the word “YES” or “NO.” The user's words would be picked up by microphone 22, detected and processed by audible module 76, and recognized by the app store program. The app store program would then process the user response accordingly, for example, by generating the necessary signals to download the corresponding discount food coupon application into the augmented reality mobile device.

It will be noted that the user may be required to take further action to effect the downloading of the application. In the present example, the user must “drag and drop” icon 71, as indicated in story board 7 (FIG. 5), in order to effect the downloading of the application. Again, the environmental component of visual module 74 would detect the user action (i.e., the motion of the user's hand) and, in response, generate a signal 96 (FIG. 4). The app store program, upon decoding signal 96, generates a download signal 97 for the augmented reality shell 64 and, more particularly, the network interaction services module 70, which in turn, sends a download instruction signal 98 to the operating system 60. The operating system 60 then effects the download over a network connection. When the downloading of the application is completed, the rendering engine may display words, text or other graphics indicative of this, as illustrated in story board 8 (FIG. 5).

The purpose of the installed application could be almost anything, as suggested above. For example, it may be an application that allows the user to order and purchase food online more quickly, in the event the line of customers waiting to order food is exceedingly long. It may be an application that allows the user to obtain a discount on various food and beverage items offered by the restaurant. It may be an application that provides the user with nutritional information about the various menu items offered by the restaurant. Thus, one skilled in the art will appreciate that the present example is not intended to limit the invention to any one type of application.

The present invention has been described above in terms of a preferred embodiment and one or more alternative embodiments. Moreover, various aspects of the present invention have been described. One of ordinary skill in the art should not interpret the various aspects or embodiments as limiting in any way, but as exemplary. Clearly, other embodiments are well within the scope of the present invention. The scope the present invention will instead be determined by the appended claims.

We claim:

1. An augmented reality mobile device comprising:
a processor including a module configured to receive and process a first signal reflecting the environment in which the augmented reality mobile device is operating and generate a second signal based on the processed first signal; and
a passively activated application program, such that the functionality is activated without direct user interaction, the passively activated application program configured to receive the second signal from the processor, recognize an environmental trigger encoded in the second signal, and effect the installation of an application in the augmented reality mobile device, wherein the application corresponds with the environmental trigger.

2. The augmented reality mobile device of claim 1 further comprising:
an output device in communication with the processor and configured to present computer-generated information to the user of the augmented reality mobile device in response to the recognition of the environmental trigger in the second signal.

3. The augmented reality mobile device of claim 2, wherein the augmented reality mobile device is a pair of augmented reality glasses, wherein the output device is a translucent display, and wherein the computer-generated information is an icon rendered on the translucent display within the user field of view.

4. The augmented reality mobile device of claim 3, wherein the processor comprises a visual module configured to receive and process a third signal reflecting a user gesture and generate a fourth signal based on the processed third signal, and wherein the passively activated application program is configured to receive the fourth signal from the processor and recognize the user gesture in the fourth signal as intent by the user to select the icon and effect the installation of the application.

5. The augmented reality mobile device of claim 1 further comprising:
a touchscreen in communication with the processor, the touchscreen configured to display computer-generated information to the user of the augmented reality mobile device in the form of an icon and in response to the recognition of the environmental trigger in the second signal, to receive a haptic input, and to generate a third signal reflecting the haptic input, wherein the passively activated application program is further configured to receive the third signal and recognize the haptic input as intent by the user to select the icon and effect the installation of the application.

6. The augmented reality mobile device of claim 2, wherein the output device is a sound generation device, and wherein the computer-generated information is a computer-generated speech pattern.

7. The augmented reality mobile device of claim 6, wherein the processor comprises an audible module configured to receive and process a third signal reflecting a user generated speech pattern and generate a fourth signal based on the processed third signal, and wherein the passively activated application program is configured to receive the fourth signal from the processor and recognize the user generated speech pattern in the fourth signal as intent by the user to respond to the computer-generated speech pattern and initiate the installation of the application.

8. The augmented reality mobile device of claim 1 further comprising:
a communication module connecting the augmented reality mobile device to a wireless network, over which the application is downloaded.

9. The augmented reality mobile device of claim 1 further comprising:
a camera configured to capture an image of the environment in which the augmented reality mobile device is operating, wherein the module in the processor is a visual module and wherein the first signal reflects the image captured by the camera.

10. The augmented reality mobile device of claim 9, wherein the environmental trigger is an object appearing in the image.

11. The augmented reality mobile device of claim 10, wherein the visual module comprises an environmental component configured to process the first signal if the environmental trigger is an object.

12. The augmented reality mobile device of claim 11, wherein the object is a glyph.

13. The augmented reality mobile device of claim 12, wherein the glyph is a QR code.

14. The augmented reality mobile device of claim 10, wherein the object is a logo.

15. The augmented reality mobile device of claim 9, wherein the environmental trigger embedded in the second signal is motion detectable in the image.

16. The augmented reality mobile device of claim 15, wherein the visual module comprises an interactive component configured to process the first signal if the environmental trigger is a motion.

17. The augmented reality mobile device of claim 1 further comprising:
a microphone configured to pick up a sound occurring in the environment in which the augmented reality mobile device is operating, wherein the module in the processor is an audible module, and wherein the environmental trigger is the sound picked up by the microphone.

18. The augmented reality mobile device of claim 17, wherein the audible processor comprises:
a tonal component configured to process the first signal if the sound is a tonal sequence.

19. The augmented reality mobile device of claim 17, wherein the audible processor comprises:
a speech component configured to process the first signal if the sound is a speech pattern.

20. The augmented reality mobile device of claim 1 further comprising:
a GPS receiver, wherein the module in the processor is a geolocational module and wherein the environmental trigger is a GPS coordinate determined by the GPS receiver.

21. The augmented reality mobile device of claim 1 further comprising:
an inertial measurement unit (IMU), wherein the module in the processor is a positional module and wherein the environmental trigger is a relative position, acceleration or orientation as determined by the IMU.

22. In augmented reality mobile device, a method of installing an application comprising:
receiving and processing a first signal reflecting the environment in which the augmented reality mobile device is operating;
generating a second signal based on the processed first signal;
without any direct, prior user interaction, decoding and analyzing the second signal for the presence of an environmental trigger; and
installing an application on the augmented reality mobile device if it is determined that an environmental trigger is encoded in the second signal, wherein the installed application corresponds with the environmental trigger.

23. The method of claim 22, wherein the first signal reflects an image captured by a camera associated with the augmented reality mobile device.

24. The method of claim 23, wherein the environmental trigger is an object present in the image.

25. The method of claim 24, wherein the object is a glyph.

26. The method of claim 25, wherein the glyph is a QR code.

27. The method of claim 24, wherein the object is a logo.

28. The method of claim 23, wherein the environmental trigger is a motion detectable in the image.

29. The method of claim 22, wherein the first signal reflects a sound picked up by a microphone associated with the augmented reality mobile device.

30. The method of claim 29, wherein the sound is a speech pattern.

31. The method of claim 29, wherein the sound is a tonal sequence

32. The method of claim 22, wherein the first signal reflects GPS coordinates as determined by a GPS receiver associated with the augmented reality mobile device.

33. The method of claim 22, wherein the first signal reflects a WIFI hotspot.

34. The method of claim 22, wherein the first signal reflects a relative position in the environment in which the augmented reality device is operating or a velocity, as determined by an inertial measurement unit associated with the augmented reality mobile device.

35. The method of claim 22 further comprising:
rendering an icon on a translucent display associated with the augmented reality mobile device in the user field of view if it is determined that an environmental trigger is present in the second signal;
detecting a user gesture and determining that the user gesture was a selection of the icon; and
initiating the installation of the application based on the determination that the user gesture was a selection of the icon.

36. The method of claim 22 further comprising:
rendering an icon on a touchscreen associated with the augmented reality mobile device if it is determined that an environmental trigger is present in the second signal;
detecting a haptic feedback signal and determining that the haptic feedback signal was a selection of the icon; and
initiating the installation of the application based on the determination that the haptic feedback signal was a selection of the icon.

37. The method of claim 22 further comprising:
generating a first speech pattern through a speaker associated with the augmented reality mobile device if it is determined that an environmental trigger is present in the second signal;
detecting a user generated speech pattern through a microphone associated with the augmented reality mobile device, and determining that the user generated speech pattern reflects an intent to install the application; and
initiating the installation of the application based on the determination that the determination that the user generated speech pattern reflected an intent to install the application.

38. The method of claim 22, wherein installing the application on the augmented reality mobile device if it is determined that an environmental trigger is encoded in the second signal comprises:
downloading the application over a wireless network connection.
